(19) United States
(12) Patent Application Publication
(10) Pub. No.: US 2025/0106939 A1
(43) Pub. Date: Mar. 27, 2025

(54) METHODS AND APPARATUSES FOR CAPABILITY REDUCTION

(71) Applicant: LENOVO (BEIJING) LIMITED, Beijing (CN)

(72) Inventors: Lianhai Wu, Beijing (CN); Prateek Basu Mallick, Dreieich (DE); Joachim Löhr, Wiesbaden (DE)

(21) Appl. No.: 18/730,914

(22) PCT Filed: Jan. 25, 2022
(86) PCT No.: PCT/CN2022/073863

§ 371 Date: Jul. 22, 2024

(51) Int. Cl. H04W 76/34; H04W 8/18; H04W 76/27

(52) U.S. Cl. CPC H04W 76/34; H04W 8/18; H04W 76/27

(57) ABSTRACT

The present disclosure relates to methods and apparatuses for capability reduction for a multi-subscriber identity module (SIM) user equipment (UE). An embodiment of the present disclosure provides a UE, which may include: a first subscriber identity module (SIM) associated with a first radio access network (RAN); a second SIM associated with a second RAN; and a processor coupled to the first SIM and the second SIM, wherein the processor is configured to: receive a first indication associated with capability reduction from the first RAN; and determine whether to switch a chain to the second RAN based on the first indication.

### TECHNICAL FIELD

The present disclosure relates to wireless communication technology, and more particularly to methods and apparatuses for capability reduction of a user equipment (UE).

### BACKGROUND OF THE INVENTION

A UE (e.g., a cell phone, a tablet, a laptop, an internet-of-things (IoT) device, etc.), which includes two or more subscriber identity modules (SIMs), can be referred to as a multi-SIM UE.

Generally, a SIM may correspond to at least one subscription in an environment where radio access technology (RAT) is adopted. For example, a multi-SIM UE may have a first SIM associated with a first subscription and a second SIM associated with a second subscription. In some examples, the first SIM and the second SIM can share the same hardware component(s), e.g., radio frequency (RF) component(s) or baseband component(s). In some examples, the first SIM and the second SIM can be associated with different hardware components.

In some scenarios, sharing the hardware component(s) may lead to a temporary hardware conflict for the UE. The industry desires technologies for facilitating the operations of a multi-SIM communication device in a communication system.

### SUMMARY

An embodiment of the present disclosure provides a UE, which may include: a first subscriber identity module (SIM) associated with a first radio access network (RAN); a second SIM associated with a second RAN; and a processor coupled to the first SIM and the second SIM, wherein the processor may be configured to: receive a first indication associated with capability reduction from the first RAN; and determine whether to switch a chain to the second RAN based on the first indication.

In some embodiments, the first indication may indicate at least one of: whether the UE is allowed to request capability reduction; a timer value for performing capability reduction without a response; whether the UE is allowed to perform capability reduction without a request; a chain shared between the first RAN and the second RAN; or a chain fully occupied by the second RAN.

In some embodiments, the processor may be further configured to transmit a request for capability reduction in the event of at least one of the following: the UE may include two or more receiving chains, two or more transmitting chains, or two or more radio frequency chains; a gap satisfying the second RAN is not configurable; a gap configured by the first RAN is insufficient to satisfy the second RAN; a requirement of quality of service (QoS) of the second RAN is not satisfied; or a chain required by the second RAN is occupied by the first RAN.

In some embodiments, the capability reduction may be per receiving chain, per transmitting chain, or per radio frequency chain.

In some embodiments, the request for capability reduction may be transmitted via a UE assistant information message.

In some embodiments, the processor may be further configured to: determine not to switch the chain in response to that a gap configured by the first RAN is sufficient to satisfy the second RAN; or determine not to request to enter into an idle state or an inactive state in the first RAN in response to that switching the chain is sufficient to satisfy the second RAN.

In some embodiments, the processor may be further configured to receive a response to the request for the capability reduction, wherein the response may indicate at least one of: releasing an secondary cell group (SCG) or releasing one or more secondary cells (SCell) via a radio resource control reconfiguration message; whether the UE is allowed to perform the requested capability reduction; one or more receiving chains, one or more transmitting chains, or one or more radio frequency chains of the UE that are allowed to or are prohibited from switching to the second RAN; or whether one or more receiving chains, one or more transmitting chains, or one or more radio frequency chains of the UE allowed to switch to the second RAN are shared between the first RAN and the second RAN.

In some embodiments, the processor may be further configured to: start a timer for capability reduction without a response in response to the transmission of the request for capability reduction; and in response to receiving a response to the request for the capability reduction, stop the timer.

In some embodiments, the processor may be further configured to: in response to the expiry of the timer, switch the requested capability to the second RAN.

In some embodiments, the processor may be further configured to, in response to performing capability reduction without a request, transmit information associated with the reduced capability to the first RAN.

Another embodiment of the present disclosure provides a BS, which may include: a transceiver; and a processor coupled to the transceiver, wherein the processor may be configured to: transmit, to a user equipment (UE), a first indication associated with capability reduction; and receive, from the UE, a request for capability reduction or information associated with a reduced capability based on the first indication.

In some embodiments, the first indication may indicate at least one of: whether the UE is allowed to request capability reduction; a timer value for performing capability reduction without a response; whether the UE is allowed to perform capability reduction without a request; a chain shared between a first radio access network (RAN) associated with the BS and a second RAN; or a chain fully occupied by the second RAN.

In some embodiments, the processor may be configured to receive a request for capability reduction via a UE assistant information message.

In some embodiments, the capability reduction may be per receiving chain, per transmitting chain, or per radio frequency chain.

In some embodiments, the processor may be further configured to transmit a response to the request for the capability reduction, wherein the response may indicate at least one of: releasing an SCG or releasing one or more SCells via a radio resource control (RRC) reconfiguration message; whether the UE is allowed to perform the requested capability reduction; one or more receiving chains, one or more transmitting chains, or one or more radio frequency chains of the UE that are allowed to or are prohibited from switching to a second RAN; or whether one or more receiving chains, one or more transmitting chains, or one or more radio frequency chains of the UE allowed to switch to a second RAN are shared between the first RAN and the second RAN.

Yet another embodiment of the present disclosure provides a method performed by a user equipment (UE), which may include: receiving a first indication associated with capability reduction from a first radio access network (RAN) associated with a first subscriber identity module (SIM) of the UE; and determining whether to switch a chain to a second RAN associated with a second SIM of the UE based on the first indication.

In some embodiments, the first indication may indicate at least one of: whether the UE is allowed to request capability reduction; a timer value for performing capability reduction without a response; whether the UE is allowed to perform capability reduction without a request; a chain shared between the first RAN and the second RAN; or a chain fully occupied by the second RAN.

In some embodiments, the method may further include transmitting a request for capability reduction in the event of at least one of the following: the UE may include two or more receiving chains, two or more transmitting chains, or two or more radio frequency chains; a gap satisfying the second RAN is not configurable; a gap configured by the first RAN is insufficient to satisfy the second RAN; a requirement of quality of service (QoS) of the second RAN is not satisfied; or a chain required by the second RAN is occupied by the first RAN.

In some embodiments, the capability reduction may be per receiving chain, per transmitting chain, or per radio frequency chain.

In some embodiments, the request for capability reduction may be transmitted via a UE assistant information message.

In some embodiments, the method may further include determining not to switch the chain in response to that a gap configured by the first RAN is sufficient to satisfy the second RAN; or determining not to request to enter into an idle state or an inactive state in the first RAN in response to that switching the chain is sufficient to satisfy the second RAN.

In some embodiments, the method may further include receiving a response to the request for the capability reduction, wherein the response may indicate at least one of: releasing an SCG or releasing one or more SCells via a RRC message; whether the UE is allowed to perform the requested capability reduction; one or more receiving chains, one or more transmitting chains, or one or more radio frequency chains of the UE that are allowed to or are prohibited from switching to the second RAN; or whether one or more receiving chains, one or more transmitting chains, or one or more radio frequency chains of the UE allowed to switch to the second RAN are shared between the first RAN and the second RAN.

In some embodiments, the method may further include starting a timer for capability reduction without a response in response to the transmission of the request for capability reduction; and in response to receiving a response to the request for the capability reduction, stopping the timer.

In some embodiments, the method may further include in response to the expiry of the timer, switching the requested capability to the second RAN.

In some embodiments, the method may further include in response to performing capability reduction without a request, transmitting information associated with the reduced capability to the first RAN.

Still another embodiment of the present disclosure provides a method performed by a base station (BS), which may include: transmitting, to a user equipment (UE), a first indication associated with capability reduction; and receiving, from the UE, a request for capability reduction or information associated with a reduced capability based on the first indication.

In some embodiments, the first indication may indicate at least one of: whether the UE is allowed to request capability reduction; a timer value for performing capability reduction without a response; whether the UE is allowed to perform capability reduction without a request; a chain shared between a first radio access network (RAN) associated with the BS and a second RAN; or a chain fully occupied by the second RAN.

In some embodiments, the method may further include receiving a request for capability reduction via a UE assistant information message.

In some embodiments, the capability reduction may be per receiving chain, per transmitting chain, or per radio frequency chain.

In some embodiments, the method may further include transmitting a response to the request for the capability reduction, wherein the response may indicate at least one of: releasing an SCG or releasing one or more SCells via a RRC message; whether the UE is allowed to perform the requested capability reduction; one or more receiving chains, one or more transmitting chains, or one or more radio frequency chains of the UE that are allowed to or are prohibited from switching to a second RAN; or whether one or more receiving chains, one or more transmitting chains, or one or more radio frequency chains of the UE allowed to switch to a second RAN are shared between the first RAN and the second RAN.

### BRIEF DESCRIPTION OF THE DRAWINGS

In order to describe the manner in which advantages and features of the disclosure can be obtained, a description of the disclosure is rendered by reference to specific embodiments thereof, which are illustrated in the appended drawings. These drawings depict only example embodiments of the disclosure and are not therefore to be considered limiting of its scope.

FIG. 1 illustrates a schematic diagram of a wireless communication system in accordance with some embodiments of the present disclosure.

FIG. 2 illustrates a flow chart of an exemplary procedure of wireless communications in accordance with some embodiments of the present disclosure.

FIG. 3 illustrates a flow chart of an exemplary procedure of wireless communications in accordance with some embodiments of the present disclosure.

FIG. 4 illustrates a block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments may be provided under a specific network architecture and new service scenarios, such as the 3rd generation partnership project (3GPP) 5G (NR), 3GPP long-term evolution (LTE), and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

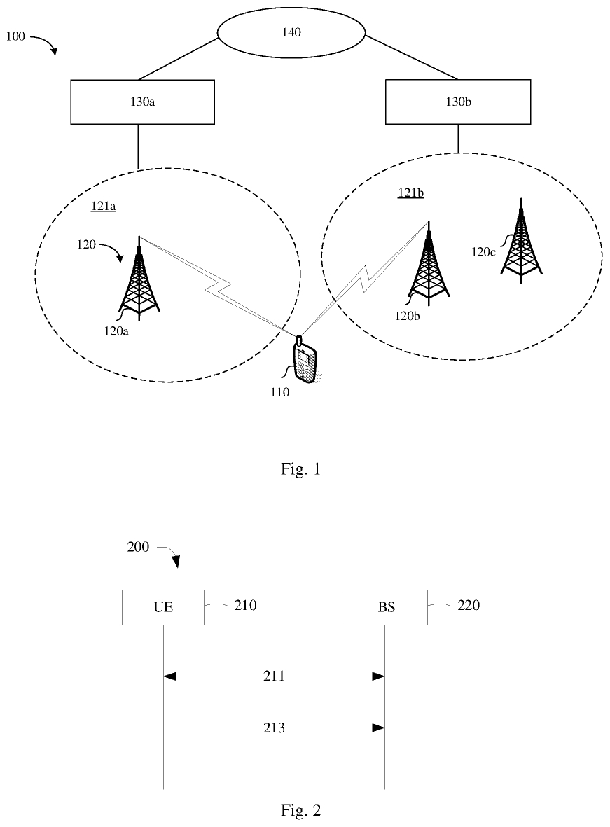

FIG. 1 illustrates a schematic diagram of a wireless communication system 100 in accordance with some embodiments of the present disclosure.

Referring to FIG. 1, a wireless communication system 100 may include some UEs (e.g., UE 110), some BSs 120 (e.g., BS 120a, BS 120b, and BS 120c), some RANs (e.g., RAN 121a and RAN 121b), some core networks (e.g., CN 130a and CN 130b), and a public switched telephone network (e.g., PSTN 140). It is contemplated that the wireless communication system 100 may include any number of UEs, BSs, networks, and/or network components.

BS 120 may operate, for example based on a standard protocol such as Long-Term Evolution (LTE), LTE-Advanced (LTE-A), New Radio (NR), or other suitable protocol(s). BS 120 may also be referred to as an access point, an access terminal, a base, a base unit, a macro cell, a Node-B, an evolved Node B (eNB), a gNB, a Home Node-B, a relay node, or a device, or described using other terminology used in the art. BS 120 may be any type of device configured to wirelessly interface with at least one UE (e.g., UE 110) to facilitate access to one or more communication networks, such as CN 130a and CN 130b.

BS 120 is generally a part of a RAN that may include one or more controllers communicably coupled to one or more corresponding BSs. In the context of the present disclosure, “configured by a RAN” can be interpreted as “configured by a BS associated with the RAN”, or vice versa. For example, referring to FIG. 1, BS 120a may be part of RAN 121a, which may also include other BSs and/or network elements (not shown), such as a base station controller (BSC), a radio network controller (RNC), relay nodes, etc. BS 120b and BS 120c may be a part of RAN 121b that in addition to, may also include other BSs and/or network elements (not shown in FIG. 1). Each of the BS 120a, BS 120b, and BS 120c may be configured to transmit and/or receive wireless signals within a particular geographic region, which may be referred to as a cell (not shown in FIG. 1).

RAN 121a may be in communication with CN 130a, and RAN 121b may be in communication with CN 130b. RAN 121a and RAN 121b may employ the same or different radio access technologies (RATs). For example, RAN 121a may employ evolved universal terrestrial radio access network (E-UTRAN) radio technology, and RAN 121b may employ NR radio technology. For example, both RAN 121a and RAN 121b may employ the NR radio technology. Each of CN 130a and CN 130b may include a plurality of core network components, such as a mobility management entity (MME) (not shown in FIG. 1) or an access and mobility management function (AMF) (not shown in FIG. 1). The CNs may serve as gateways for the UEs to access PTSN 140 and/or other networks (not shown in FIG. 1).

UE 110 may be any type of device configured to operate and/or communicate in a wireless environment. For example, UE 110 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE 110 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE 110 includes wearable devices, such as smart watches, fitness bands, optical head-mounted displays, or the like. Moreover, UE 110 may be referred to as a subscriber unit, a mobile, a mobile station, a user, a terminal, a mobile terminal, a wireless terminal, a fixed terminal, a subscriber station, a user terminal, or a device, or described using other terminology used in the art. UE 110 may communicate with BS 120 via uplink (UL) communication signals. BS 102 may communicate with UE 110 via downlink (DL) communication signals.

UE 110 may include one or more subscriber identity modules (SIMs) that enable it to access one or more separate wireless communication networks. As shown in FIG. 1, UE 110 may be configured to access either RAN 121a through BS 120a by virtue of SIM #1 (not shown in FIG. 1) in UE 110 or RAN 121b through BS 120b by virtue of SIM #2 (not shown in FIG. 1) in UE 110. While UE 110 is shown accessing RAN 121a and RAN 121b, in other examples (not shown), the UE 110 may establish additional network connections using additional RATs, for example, by virtue of another SIM(s) in addition to SIM #1 and SIM #2.

Each of SIM #1 and SIM #2 may be associated with a kind of wireless communication system. For example, either SIM #1 and SIM #2 may be represented by a SIM card corresponding to a GSM system, a universal subscriber identity module (USIM) card corresponding to a UMTS system, a removable user identity module (RUIM) card or a CDMA subscriber identity module (CSIM) card corresponding to the CDMA2000 communication system, a universal integrated circuit card (UICC) corresponding to the 5G (NR) communication system, a wireless network card corresponding to IEEE 802.11x wireless local area network (WLAN), or other suitable modules that can identify subscribers.

In some examples, a multi-SIM UE may be implemented as a multi-SIM-single-standby (MSSS) UE, a multi-SIM-multi-standby (MSMS) UE, a multi-SIM-multi-active (MSMA) UE, etc.

For example, a UE that includes a plurality of SIMs and connects to two or more networks with two or more SIMs being active at a given time may be referred to as an MSMA UE. An example MSMA UE may be a dual-SIM-dual-active (DSDA) UE, which may include two SIMs. Both SIMs of a DSDA UE may remain active. For example, a UE provided with a plurality of SIMs and connected to two or more networks with one SIM being active at a given time may be referred to as an MSMS UE. An example of the MSMS UE may be a dual-SIM-dual-standby (DSDS) UE. A DSDS UE may include two SIMs, and may use a single radio front-end and baseband to register the communication device to a single (the same) public land mobile network or to two different PLMNs with the two SIMs, respectively.

In a multi-SIM UE, the plurality of SIMs may share the hardware capabilities of the UE, so as to use the hardware efficiently and economically. For example, the hardware capabilities of a UE may include two or more receiving (Rx) chains, two or more transmitting (Tx) chains, and/or two or more RF chains. Each RF chain may include at least one Rx chain and at least one Tx chain. Sharing an RF chain may refer to sharing the Rx and Tx chains of the RF chain.

However, sharing hardware capabilities may lead to a temporary hardware conflict for the UE. For example, referring to FIG. 1, when UE 110 is in a connected state in RAN 121a, and UE 110 is in an idle or inactive sate in RAN 121b, all the RF chains may be occupied by SIM #1 of UE 110 for the communications in RAN 121a. When UE 110 enters into a connected state in RAN 121b via SIM #2, an Rx chain, a Tx chain or an RF chain may need to be switched to RAN 121b.

In this case, if RAN 121a is not aware of the UE's reduced capability change, there may be data loss due to demodulation failure and wasting radio resources in RAN 121a. To avoid the above issues, assistance information from UE 110 to RAN 121a on these temporary UE (or UE capability) restrictions may be beneficial.

FIG. 2 illustrates a flow chart of an exemplary procedure 200 of wireless communications in accordance with some embodiments of the present disclosure. Details described in all of the foregoing embodiments of the present disclosure are applicable for the embodiments shown in FIG. 2. It should be appreciated by persons skilled in the art that the sequence of the operations in exemplary procedure 200 may be changed and some of the operations in exemplary procedure 200 may be eliminated or modified, without departing from the spirit and scope of the disclosure.

Referring to FIG. 2, UE 210 and BS 220 may function as UE 110 and BS 120 shown in FIG. 1, respectively. In operation 211, UE 210 and BS 220 may interact to perform an RRC reconfiguration operation involving UE 210. For example, BS 220 may transmit an RRC reconfiguration message to UE 210. The RRC reconfiguration message may indicate UE 210 to report assistant information to BS 220. Under certain scenarios, UE 210 may, in operation 213, transmit a UE assistance information message to BS 220.

For example, the UE may use the UE assistance information message to inform the network of the following information:
its delay budget report carrying desired increment/decrement in the connected mode discontinuous reception (DRX) cycle length;
its overheating assistance information;
its in-device coexistence (IDC) assistance information;
its preference on DRX parameters for power saving;
its preference on the maximum aggregated bandwidth for power saving;
its preference on the maximum number of secondary component carriers for power saving;
its preference on the maximum number of multiple-input and multiple-output (MIMO) layers for power saving;
its preference on the minimum scheduling offset for cross-slot scheduling for power saving;
its preference on the RRC state;
configured grant assistance information for NR sidelink communication;
its preference in being provisioned with reference time information;
its multi-SIM (e.g., multiple USIM (MUSIM)) assistance information; or
any combination thereof.

In some embodiments of the present disclosure, a UE capable of providing multi-SIM assistance information may initiate the above procedure (e.g., if the UE is configured to do so) in response to determining to leave a connected state or that it needs a gap(s), or in response to, for example, a change of the gap information without leaving the connected state.

In some embodiments of the present disclosure, a UE may use the above procedure to provide information related to a reduced capability (e.g., an Rx chain, a Tx chain or an RF chain) to a BS.

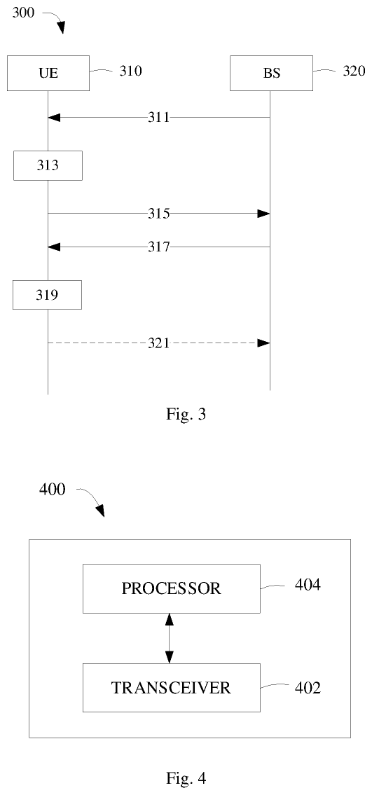

FIG. 3 illustrates a flow chart of an exemplary procedure 300 of wireless communications in accordance with some embodiments of the present disclosure. Details described in all of the foregoing embodiments of the present disclosure are applicable for the embodiments shown in FIG. 3.

In FIG. 3, UE 310 and BS 320 may function as UE 110 and BS 120 shown in FIG. 1, respectively. Hereinafter in the present disclosure, the solutions are described with UE 310 that includes two SIMs (e.g., SIM #3A and SIM #3B), and it should be noted that the solutions also apply to UEs with more than two SIMs, and can access more than two RANs.

In operation 311, UE 310 may receive a configuration message (e.g., an RRC reconfiguration message) from BS 320 associated with network #3A. UE 310 may access BS 320 or network #3A via SIM #3A. For example, UE 310 may be in a connected state in network #3A. UE 310 may be in an idle or inactive state in another network (denoted as “network #3B”). Network #3B may be associated with SIM #3B.

In some embodiments, the configuration message may indicate that UE 310 is allowed to request a gap, or UE 310 is allowed to request a preferred state, e.g., idle state or inactive state. A gap configuration may indicate a time duration, optionally a period, that a UE is maintained in a connected state in a network (e.g., network #3A) while temporarily switching to another network (e.g., network #3B).

In some embodiments, the configuration message may indicate that UE 310 is allowed to request capability reduction to BS 320. The capability reduction request may be per RF chain, per TX chain, and/or per RX chain. The capability reduction request may indicate any combination of a RF chain(s), a TX chain(s), and a RX chain(s). In some examples, UE 310 may determine whether to transmit a request for capability reduction (e.g., whether to switch a chain occupied by network #3A to network #3B, or whether to switch a chain to network #3B) based on this indication.

For example, UE 310 may include two or more Rx chains, two or more Tx chains, and/or two or more RF chains. Each RF chain may include at least one Rx chain and at least one Tx chain. For simplicity, it is assumed that UE 310 includes Rx chain #1 and Rx chain #2, Tx chain #1 and Tx chain #2, RF chain #1 includes Rx chain #1 and Tx chain #1, RF chain #2 includes Rx chain #2 and TX chain #2.

In some examples, the reduced capability may be per Rx chain, such as, requesting switching Rx chain #1 from network #3A to network #3B. In some examples, the reduced capability may be per Tx chain, such as, requesting switching Tx chain #1 from network #3A to network #3B. In some examples, the reduced capability may be per RF chain, such as, requesting RF chain #1 from network #3A to network #3B. In some examples, the capability reduction may be per Rx chain and per Tx chain, per Rx chain and per RF chain, per Tx chain and per RF chain, or per Rx chain, per Tx chain, and per RF chain. For instance, UE 310 may request switching Tx chain #1 and RF chain #2 from network #3A to network #3B.

In some embodiments, the configuration message may indicate a value for a timer for switching without response. For example, with this configured timer value, in the case of no response to the capability reduction request, UE 310 is allowed to switch the requested capability (e.g., an Rx chain(s), a Tx chains, an RF chain(s) or any combination thereof) in response to the expiry of the timer. Detailed descriptions of the timer will be described in the following text of the present disclosure.

In some embodiments, the configuration message may indicate that UE 310 can switch a hardware capability (e.g., an Rx chain(s), a Tx chains, an RF chain(s) or any combination thereof) autonomously from network #3A to another network (e.g., network #3B) without a request. Detailed descriptions of the autonomous capability reduction will be described in the following text of the present disclosure.

In some embodiments, the configuration message may indicate a switched capability (e.g., a chain) shared between network #3A and the another network (e.g., network #3B). In some embodiments, the configuration message may indicate a switched capability (e.g., a chain) to be fully occupied by the another network (e.g., network #3B).

In operation 313, the UE may determine to switch to network #3B. The UE may make such determination in various scenarios including but not limiting to the following:
Scenario 1: periodic switching, such as for paging reception in network #3B, or for performing measurements in network #3B.
Scenario 2: aperiodic switching, such as tracking area update (TAU), RAN-based notification area update (RNAU), mobile originate short message service (MO SMS), voice over LTE (VoLTE) or voice over NR (VoNR) voice call in network #3B.
Scenario 3: UE 310 may include at least two Rx chains. UE 310 is in a connected state in network #3A, and needs to switch part of the Rx capability (e.g., a Rx chain) to network #3B, where the UE is in an idle state or inactive state in network #3B, UE 310 changes its Rx capability in network #3A for DL reception in network #3B.
Scenario 4: aperiodic (e.g., one-shot) switching. For example, UE 310 enters into a connected state (e.g., with RRC connection resume/setup) in network #3B, including registration, SMS, RAU, busy indication, etc.

UE 310 may transmit various requests including but not limiting to the following to switch to network #3B: a gap request; a request for reducing capability; and a request for a preferred state (e.g., entering into idle state or inactive state in network #3A). In some embodiments, UE 310 may transmit a gap request in preference to a request for reducing capability and a request for the preferred state. UE 310 may transmit a request for reducing capability in preference to a request for the preferred state. That is, the priority of gap request is higher than that of a request for capability reduction, which is higher than that of a request for a preferred state.

In some embodiments, UE 310 may determine which request is to be transmitted based on the following criteria:
i. If the gap can meet the requirement for network #3B, UE 301 should request a gap in preference to the request for reducing capability and the request for the preferred state.
ii. In the case that, for example, UE 301 supports a capability reduction, a gap satisfying network #3B is not configurable, a gap configured by network #3A is insufficient to serve network #3B, a requirement of quality of service (QoS) of network #3B cannot be satisfied, or a capability (e.g., a chain) required by network #3B is occupied by network #3A, UE 310 may request a capability reduction.
iii. In the case that, for example, UE 301 does not support a capability reduction or a capability reduction is insufficient to serve network #3B, UE 310 may request to transit to an idle state or inactive state in network #3A.

For example, a UE supporting a capability reduction may mean that the UE including two or more Tx chains, two or more Rx chains, or two or more RF chains. A UE including only one Tx chain and one Rx chain may be deemed as not supporting the capability reduction. In other words, only a UE with at least two Tx chains, at least two Rx chains or both may be allowed to transmit a capability reduction request.

For example, a gap satisfying a network being not configurable may mean that UE 301 is not allowed to request a gap by network #3A that can satisfy the requirement of network #3B because, for example, the requested gap is longer than a threshold or the periodicity of the requested gap is high (e.g., higher than a threshold).

For example, a gap configured by a network being insufficient to serve another network may mean that the gap configured by network #3A is insufficient to serve network #3B. For instance, among all the gaps configured by network #3A, none of them can satisfy the requirement of network #3B.

For example, a requirement of QoS of a network cannot be satisfied may mean that a gap configuration cannot meet the QoS requirement (e.g., transmission speed, latency requirement, and so on) of network #3B.

For example, a capability required by a network being occupied by another network may mean that an Rx chain(s), a Tx chain(s), or a RF chain(s) required by a network #3B is occupied by network #3A. For instance, UE 310 may want to enter into a connected state in network #3B (e.g., to receive DL data or transmit UL data). However, the RF capability, Tx capability, or Rx capability required by network #3B are occupied by network #3A. In this case, the UE may transmit the request for capability reduction to BS 320 (or network #3A).

In operation 315, UE 310 may transmit the request for capability reduction to BS 320. In some examples, the request may be included in a UE assistance information message. In some examples, the request may be included in other messages such as a dedicated message. The request for capability reduction may indicate an Rx chain(s), a Tx chain(s), a RF chain(s), or any combination thereof.

In some embodiments, UE 310 may be configured with a value for a timer for capability reduction without a response. In response to transmitting the request, UE 310 may start the timer. If UE 310 does not receive a response to the request until the timer expires, UE 310 may autonomously switch the requested capability (e.g., an Rx chain(s), a Tx chain(s), a RF chain(s), or any combination thereof) to network #3B. If UE 310 receives a response to the request while the timer is still running, UE 310 may stop the timer.

In operation 317, in response to receiving the request from UE 310, BS 320 may transmit a response to UE 310. The response may be implemented in various manners as will be detailed in the following text. The below embodiments regarding the response can be used alone or in any combination thereof.

In some embodiments, the response may indicate releasing an SCG or releasing one or more SCells and may be transmitted via an RRC reconfiguration message. In some examples, the RRC reconfiguration message may indicate a release of a secondary cell group (SCG) of network #3A, which may suggest that BS 320 approve all or at least a part of the capability reduction request. In some examples, the RRC reconfiguration message may indicate releasing one or more SCell. For example, the capability reduction request may request to release a number of cells (X SCells). The RRC reconfiguration message may indicate the UE to release a number of cells (Y SCells). X and Y may be different or identical. In some examples, the RRC reconfiguration message may not indicate any cell release, which may suggest that BS 320 rejects the capability reduction request.

In some embodiments, the response may explicitly indicate whether the request is permitted or rejected. That is, the response may indicate whether the UE is allowed to perform the requested capability reduction. Such indication may include one-bit. For example, the value of “1” may indicate permission, and the value of “0” may indicate rejection; or vice versa. The indication may be included in an RRC reconfiguration message, or any other messages such as a dedicated message.

In some embodiments, the response may indicate the specific Tx chain(s), Rx chain(s), RF chain(s), or any combination thereof, which is allowed or prohibit from switching to network #3B. For example, the indication may indicate that RF chain #1 can be switched to network #3B.

In some embodiments, the response may indicate whether the Rx chain(s), Tx chain(s), or RF chain(s) to be switched are shared between network #3A and network #3B, or fully occupied by network #3B.

In operation 319, based on the response from BS 320, UE 310 may switch a corresponding capability (e.g., a Tx chain(s), a Rx chain(s), a RF chain(s), or any combination) to network #3B.

In some embodiments, UE 310 may be configured with autonomously capability reduction without a request. When UE 310 determines to reduce its capability associated with network #3A, UE 310 may not transmit a capability reduction request to BS 320 as described above, and may autonomously perform a capability reduction (e.g., switch a chain occupied by network #3A to network #3B, or switch a chain to network #3B). In operation 321, in response to the capability reduction without a request, UE 310 may transmit information associated the reduced capability (e.g., a switched RF chain, RX chain or TX chain) to BS 320.

It should be appreciated by persons skilled in the art that the sequence of the operations in exemplary procedure 300 may be changed and some of the operations in exemplary procedure 300 may be eliminated or modified, without departing from the spirit and scope of the disclosure.

FIG. 4 illustrates a block diagram of an exemplary apparatus 400 according to some embodiments of the present disclosure. As shown in FIG. 4, the apparatus 400 may include at least one processor 404 and at least one transceiver 402 coupled to the processor 404. The apparatus 400 may be a UE or a BS.

Although in this figure, elements such as the at least one transceiver 402 and processor 404 are described in the singular, the plural is contemplated unless a limitation to the singular is explicitly stated. In some embodiments of the present disclosure, the transceiver 402 may be divided into two devices, such as a receiving circuitry and a transmitting circuitry. In some embodiments of the present disclosure, the apparatus 400 may further include an input device, a memory, and/or other components.

In some embodiments of the present disclosure, the apparatus 400 may be a UE. The transceiver 402 and the processor 404 may interact with each other so as to perform the operations with respect to the UE described above, for example, in FIGS. 1-3.

In some embodiments of the present disclosure, the apparatus 400 may be a BS. The transceiver 402 and the processor 404 may interact with each other so as to perform the operations with respect to the BS described above, for example, in FIGS. 1-3.

In some embodiments of the present disclosure, the apparatus 400 may further include at least one non-transitory computer-readable medium. For example, in some embodiments of the present disclosure, the non-transitory computer-readable medium may have stored thereon computer-executable instructions to cause the processor 404 to implement the method with respect to the UE as described above. For example, the computer-executable instructions, when executed, cause the processor 404 interacting with transceiver 402 to perform the operations with respect to the UE described in FIGS. 1-3.

In some embodiments of the present disclosure, the apparatus 400 may further include at least one non-transitory computer-readable medium. For example, in some embodiments of the present disclosure, the non-transitory computer-readable medium may have stored thereon computer-executable instructions to cause the processor 404 to implement the method with respect to the BS as described above. For example, the computer-executable instructions, when executed, cause the processor 404 interacting with transceiver 402 to perform the operations with respect to the BS described in FIGS. 1-3.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
a first subscriber identity module (SIM) associated with a first radio access network (RAN);
a second SIM associated with a second RAN;
at least one memory; and
at least one processor coupled with the at least one memory, the first SIM, and the second SIM, wherein the at least one processor is configured to cause the UE to:
receive a first indication associated with capability reduction from the first RAN; and
determine whether to switch at least one capability chain to the second RAN based on the first indication.

2. The UE of claim 1, wherein the first indication indicates at least one of:
whether the UE is allowed to request capability reduction;
a timer value for performing capability reduction without a response;
whether the UE is allowed to perform capability reduction without a request;
a capability shared between the first RAN and the second RAN; or
a capability fully occupied by the second RAN.

3. The UE of claim 1, wherein the at least one processor is configured to cause the UE to transmit a request for capability reduction in the event of at least one of the following:
the UE comprises two or more receiving chains, two or more transmitting chains, or two or more radio frequency chains;
a gap satisfying the second RAN is not configurable;
a gap configured by the first RAN is insufficient to satisfy the second RAN;
a requirement of quality of service (QOS) of the second RAN is not satisfied; or
a capability required by the second RAN is occupied by the first RAN.

4. The UE of claim 1, wherein a capability reduction is per receiving capability, per transmitting capability, or per radio frequency capability.

5. The UE of claim 3, wherein the request for capability reduction is transmitted via a UE assistant information message.

6. The UE of claim 1, wherein the at least one processor is configured to cause the UE to:
determine not to switch the at least one capability in response to that a gap configured by the first RAN is sufficient to satisfy the second RAN; or
determine not to request to enter into an idle state or an inactive state in the first RAN in response to that switching the at least one capability is sufficient to satisfy the second RAN.

7. The UE of claim 3, wherein the at least one processor is configured to cause the UE to receive a response to the request for the capability reduction, wherein the response indicates at least one of:
releasing a secondary cell group (SCG) or releasing one or more secondary cells (SCell) via a radio resource control reconfiguration message;
whether the UE is allowed to perform the requested capability reduction;
one or more receiving capabilities, one or more transmitting capabilities, or one or more radio frequency capabilities of the UE that are allowed to or prohibited from switching to the second RAN; or
whether one or more receiving capabilities, one or more transmitting capabilities, or one or more radio frequency capabilities of the UE allowed to switch to the second RAN are shared between the first RAN and the second RAN.

8. The UE of claim 3, wherein the at least one processor is configured to cause the UE to:
start a timer for capability reduction without a response in response to the transmission of the request for capability reduction; and
in response to receiving a response to the request for the capability reduction, stop the timer.

9. The UE of claim 8, wherein the at least one processor is configured to cause the UE to:
in response to the expiry of the timer, switch the requested capability to the second RAN.

10. The UE of claim 1, wherein the at least one processor is configured to cause the UE to, in response to performing capability reduction without a request, transmit information associated with the reduced capability to the first RAN.

11. A base station, comprising:
at least one memory; and
at least one processor coupled with the at least one memory and configured to cause the base station to:
transmit, to a user equipment (UE), a first indication associated with capability reduction; and
receive, from the UE, a request for capability reduction or information associated with a reduced capability based on the first indication.

12. The base station of claim 11, wherein the first indication indicates at least one of:
whether the UE is allowed to request capability reduction;
a timer value for performing capability reduction without a response;
whether the UE is allowed to perform capability reduction without a request;
a capability shared between a first radio access network (RAN) associated with the base station and a second RAN; or
a capability fully occupied by the second RAN.

13. The base station of claim 11, wherein the at least one processor is configured to cause the base station to receive a request for capability reduction via a UE assistant information message.

14. The base station of claim 11, wherein the capability reduction is per receiving capability, per transmitting capability, or per radio frequency capability.

15. The base station of claim 13, wherein the at least one processor is configured to cause the base station to transmit a response to the request for the capability reduction, wherein the response indicates at least one of:
releasing a secondary cell group (SCG) or releasing one or more secondary cells (SCell) via a radio resource control reconfiguration message;
whether the UE is allowed to perform the requested capability reduction;
one or more receiving capabilities, one or more transmitting capabilities, or one or more radio frequency capabilities of the UE that are allowed to or prohibited from switching to a second RAN; or
whether one or more receiving capabilities, one or more transmitting capabilities, or one or more radio frequency capabilities of the UE allowed to switch to a second RAN are shared between the first RAN and the second RAN.

16. A processor for wireless communication, comprising:
at least one controller coupled with at least one memory and configured to cause the processor to:
receive a first indication associated with capability reduction from a first radio access network (RAN); and
determine whether to switch at least one capability to a second RAN based on the first indication.

17. The processor of claim 16, wherein the first indication indicates at least one of:
whether the UE is allowed to request capability reduction;
a timer value for performing capability reduction without a response;
whether the UE is allowed to perform capability reduction without a request;
a capability shared between the first RAN and the second RAN; or
a capability fully occupied by the second RAN.

18. The processor of claim 16, wherein the at least one controller is configured to cause the processor to transmit a request for capability reduction in the event of at least one of the following:
the processor comprises two or more receiving capabilities, two or more transmitting capabilities, or two or more radio frequency capabilities;
a gap satisfying the second RAN is not configurable;
a gap configured by the first RAN is insufficient to satisfy the second RAN;
a requirement of quality of service (QOS) of the second RAN is not satisfied; or
a capability required by the second RAN is occupied by the first RAN.

19. The processor of claim 16, wherein capability reduction is per receiving capability, per transmitting capability, or per radio frequency capability.

20. A method performed by a user equipment (UE), the method comprising:
receiving a first indication associated with capability reduction from a first radio access network (RAN); and
determining whether to switch at least one capability to a second RAN based on the first indication.
